(19) United States
(12) Patent Application Publication
(10) Pub. No.: US 2018/0088378 A1
(43) Pub. Date: Mar. 29, 2018

(54) POLARIMETRIC-ANALYSIS-TYPE DUAL LIQUID CRYSTAL WAVELENGTH FILTER MODULE

(71) Applicant: Electronics and Telecommunications Research Institute, Daejeon (KR)

(72) Inventors: Hyoung Jun PARK, Gwangju (KR); Hyun Seo KANG, Gwangju (KR); Keo Sik KIM, Gwangju (KR); Sung Chang KIM, Gwangju (KR); Young Sun KIM, Gwangju (KR); Jeong Eun KIM, Gwangju (KR); Hee Seung KIM, Gwangju (KR); Ji Hyoung RYU, Jeonju-si Jeollabuk-do (KR); Dong Hoon SON, Gwangju (KR); Chan Il YEO, Gwangju (KR); Young Soon HEO, Gwangju (KR)

(73) Assignee: Electronics and Telecommunications Research Institute, Daejeon (KR)

(21) Appl. No.: 15/499,392

(22) Filed: Apr. 27, 2017

(30) Foreign Application Priority Data
Sep. 28, 2016 (KR) 1020160124955
Feb. 7, 2017 (KR) 1020170016892

(51) Int. Cl. G02F 1/1347; G02F 1/13363; G02F 1/135; G02F 1/1335; G01J 4/00

(52) U.S. Cl. CPC G02F 1/1347; G02F 1/13363; G02F 1/1354; G02F 1/133526; G02F 2201/58; G02F 2001/133638; G02F 2413/01; G02F 2413/05; G01J 4/00

(57) ABSTRACT

Disclosed is a polarimetric-analysis-type dual liquid crystal (LC) wavelength filter module capable of miniaturization or optical integration in the form of a package. The polarimetric-analysis-type dual liquid crystal (LC) wavelength filter module includes a beam displacer disposed on a propagation path of light of an unpolarized light source for emitting unpolarized light and configured to generate two orthogonal polarization components corresponding to two polarization axes from the light of the unpolarized light source such that the polarization components are separated at a predetermined angle, a half-wavelength retarder disposed apart at a rear end of the beam displacer along the light propagation path, and a dual LC wavelength-tunable filter having two LC wavelength-tunable filters that overlap with a gap therebetween to detect light intensities of first polarized light of a Transverse Electric (TE) mode that is directly delivered from the beam displacer and second polarized light of the TE mode that is transmitted through or via the half-wavelength retarder and then converted.

### CROSS-REFERENCE TO RELATED APPLICATION

This application claims priority to and the benefit of Korean Patent Application No. 10-2016-0124955, filed on Sep. 28, 2016, and No. 10-2017-0016892, filed on Feb. 7, 2017, the disclosure of which is incorporated herein by reference in its entirety.

### BACKGROUND

### 1. Field of the Invention

The present invention relates to a polarimetric-analysis-type dual liquid crystal (LC) wavelength filter module, and more particularly, to a polarimetric-analysis-type dual LC wavelength filter module having a core technology for an optical integrated module structure applicable to a communication narrow-band wavelength filter, an optical wavelength detection module, an optical-spectrum demodulation and optical power and wavelength meter by combining a plurality of LC wavelength filters with a tunable optical retarder, which is an LC retarder.

### 2. Discussion of Related Art

In recent years, global IP traffic tends to increase rapidly due to the wide use of Internet access terminals such a tablet PC, a smartphone, etc., the increase in Internet users, and the development of high-speed Internet. The existing aged equipment is replaced with the latest equipment to prepare for the traffic that is rapidly increasing in the future, but a super-high-speed and large-capacity communication band is required due to an exclusive increase in subscribers of high-speed mobile communication networks such as a broadband Long Term Evolution (LTE) network, Internet protocol TV (IPTV) services, etc. Thus, demand for multifunctional optical meters is increasing to maintain an optical communication system and transmission lines that are responsible for a large-capacity communication band.

Generally, an optical meter has only a function of measuring optical wavelengths/power and includes a wavelength-tunable filter module. However, because of structural features of the existing wavelength-tunable filter module, it is difficult to utilize an optical meter including such a tunable filter module to produce a mobile optical meter having a built-in ferrule section inspection function.

As disclosed in Korea Patent No. 10-2016-0150534, an optical meter configured to convert desired wavelength and power components into electrical signals through two detectors, reflect undesired components to detect the reflected components through another detector, compare the detected data with original data values, and analyze the wavelength components is present as the conventional technology associated with the optical meter.

Also, an optical power and wavelength meter with Coarse Wavelength Division Multiplexing (CWDM) is present as another technology. In the optical power and wavelength meter, a plurality of optical filters are disposed in zigzags in both length directions of a light receiving unit so that light incident through an optical connector may be continuously reflected in zigzags. Each optical filter identifies an optical wavelength or measures an optical intensity using a thin film filter of CWDM, Dense Wavelength Division Multiplexing (DWDM), or the like and performs filtering of at least 18 wavelengths.

As still another technology, there is present an optical meter including one or more optical wavelength divider configured to output an optical signal having multiple wavelengths as a plurality of optical signals having single-wavelength bands and an optical array sensor configured to receive each optical signal having a single wavelength band output from the optical wavelength divider.

Also, there is an optical meter that has optical filters for detecting wavelengths disposed in a stepped shape and that is configured to measure an optical wavelength and optical power of light transmitted through the optical filters by using an optical detector according to transmission and reflection characteristics of the optical filters.

As still another technology, there is present an optical meter configured to divide an optical signal into wavelengths through an optical wavelength divider when the optical signal is input and configured to measure an optical wavelength and optical power of a corresponding signal through a photodiode when light with an unknown wavelength is input. When light with multiple wavelengths is input, the optical meter measures wavelength information and optical power of each optical wavelength.

As still another technology, there is a technology for canceling polarization dependency of a polarization-dependent liquid crystal (LC)-based filter by dividing input light according to x and y polarization axis of a Wollaston prism and matching one polarized light beam with the other polarized light beam through a half wave plate.

For example, as shown in FIG. 1, a Wollaston prism 1 with birefringence properties consists of two orthogonal calcite prisms 1a and 1b, which are two right triangle prisms each having a vertical optical axis. Incident unpolarized light is split into two orthogonal polarized light beams and divergent from the prisms 1a and 1b according to a divergence angle corresponding to a prism wedge angle. Accordingly, when the Wollaston prism 1 is applied, polarimetric analysis of incident light is possible by dividing the incident light in two polarization axes to detect light intensities according to the polarization axes.

A liquid crystal (LC) may have a transmissive structure. An optical retarder 2 capable of adjusting birefringence is easy to implement as shown in FIG. 2A and may have a change in birefringence by using the LC as shown in FIG. 2B.

Referring to FIG. 2A, FIG. 2B, and Equation 1, when a voltage is applied to the optical retarder 2, which is a transmissive LC, the optical retarder 2 can be applied as a polarization modulator for modulating incident polarized light.

[Equation 1]

n_{eff}=n₁n₂/\sqrt{(n₁² sin² θ+n₂² cos² θ)} \textcircled{1}

OPTICAL RETARDATION(R)=2πd(n_{eff}−n₂)/λ \textcircled{2}

where n_{eff} is an effective refractive index of the LC, d is a thickness (gap) of the LC, λ is a wavelength of incident light, and R is an optical retardation effect.

FIG. 3 shows a Fabry-Perot LC filter, which is an LC-based wavelength-tunable filter. Here, the Fabry-Perot LC filter includes two parallel mirror glasses 3a and 3b and a material injected thereinto and having a predetermined refraction index, that is, a liquid crystal 4. Light having only a wavelength selected from incident light 5 according to resonance characteristics with respect to a distance d between the mirror glasses 3a and 3b is transmitted through the Fabry-Perot LC filter to form transmitted light 6. That is, a small amount of light is transmitted by the mirror glasses 3a and 3b. When the incident light 5 is incident to one mirror glass 3a, most of the incident light 5 is reflected, but only the transmitted light 6 having one wavelength extracted by a resonance effect may pass therethrough.

Accordingly, when a certain intensity of electric field is applied to the liquid crystal 4, molecules of the liquid crystal 4 are rearranged, and thus the refractive index of the liquid crystal 4 can be adjusted according to the intensity of the electric field. Accordingly, the effect of varying the distance d between the two mirror glasses 3a and 3b can be obtained.

For example, as shown in FIG. 4, when a voltage is applied to the Fabry-Perot LC filter, that is, an LC-based wavelength-tunable filter, a filter transmission resonance wavelength changes with a change in refractive index of the liquid crystal with respect to the applied voltage. Accordingly, the Fabry-Perot LC filter may be used as a wavelength-tunable filter.

The LC wavelength-tunable filter has a transmission wavelength with polarization properties of a Transverse Electric (TE) mode and thus cannot compensate for an optical loss of a Transverse Magnetic (TM) mode according to a polarization axis. Accordingly, a compensation unit for the loss is being required.

For example, as the conventional technology, Japanese Patent Application Laid-Open No. 1994-148692 discloses a liquid-crystal Fabry Perot etalon obtained by injecting a liquid crystal into a Fabry Perot etalon in which two glass substrates each having a dielectric mirror, a transparent electrode, and a liquid crystal alignment film installed therein are installed at a predetermined interval to face each other. The liquid crystal has a wavelength-tunable liquid crystal light filter structure in which a liquid crystal molecule axis has a helical structure parallel to the glass substrates, but has polarization caused by the structure of the liquid crystal. Accordingly, polarization dependent loss occurs in the liquid crystal.

Also, U.S. Pat. No. 8,988,680 proposed a structure for processing combination and division of polarized images by using liquid crystal tunable filters having wide pass-bands. That is, a structure of dividing light reflected by an object into a TE mode (S-polarization) and a TM mode (P-polarization), transmitting the divided light through a wavelength filter, and obtaining an image through a charge-coupled device (CCD) camera was proposed. The proposed structure has disadvantages of forming a bulky device, having a complex structure, and being difficult to miniaturize.

Also, U.S. Pat. No. 8,736,777 proposed a Visible Spectroscopy-Near Infrared Spectroscopy (VIS-NIR) hyperspectral imaging filter, which has serial stages with combinations of angularly distributed birefringent retarders and polarizers. In this case, each spectrum includes a tunable wavelength band, and spectral imaging suitable for a wavelength filter is formed in narrow bandpass and wide spectral spacing ranges that apply together. In this case, the filter is an image filter, which is obtained by simply combining LC wavelength filters, and thus cannot implement miniaturization of optical integration because of its system structure.

### SUMMARY OF THE INVENTION

The present invention is directed to providing a polarimetric-analysis-type dual liquid crystal wavelength filter module, which is a miniaturized optical integrated module having the form of a package such as a TO-CAN structure, that may be used as an optical module capable of polarimetric analysis with respect to a wavelength of incident light corresponding to a polarization axis, a power and wavelength measurement module, a polarization switch, and a narrow-band-light-tunable power and wavelength filter by organically combining a beam displacer, which is a birefringent optical device, a half-wavelength retarder, which is a tunable optical retarder, and a dual LC wavelength-tunable filter, which is an LC-based wavelength-tunable filter.

According to an aspect of the present invention, there is provided a polarimetric-analysis-type dual liquid crystal (LC) wavelength filter module including a beam displacer disposed on a propagation path of light of an unpolarized light source that emits unpolarized light and configured to generate two orthogonal polarization components corresponding to two polarization axes from the light of the unpolarized light source such that the polarization components are separated at a predetermined angle, a half-wavelength retarder disposed apart at a rear end of the beam displacer along the light propagation path, and a dual LC wavelength-tunable filter having two LC wavelength-tunable filters that overlap with a gap therebetween to detect light intensities of first polarized light of a Transverse Electric (TE) mode that is directly delivered from the beam displacer and second polarized light of the TE mode that is transmitted through or via the half-wavelength retarder and then converted.

The half-wavelength retarder may be a fixed half-wavelength retarder or a tunable retarder that uses a LC and may be composed of a device configured to convert polarized light of a Transverse Magnetic (TM) mode, which is the orthogonal polarization components of the polarization axes, into polarized light of the TE mode, which is capable of being transmitted through the LC wavelength-tunable filters.

The polarimetric-analysis-type dual LC wavelength filter module may further include an optical detector disposed at a rear end of the dual LC wavelength-tunable filter and configured to detect optical intensities of the first polarized light and the second polarized light that are transmitted through the dual LC wavelength-tunable filter.

The optical detector may be composed of a first photodiode disposed on a light path of the second polarized light and a second photodiode disposed on a light path of the first polarized light with respect to a position where light is emitted from the dual LC wavelength-tunable filter.

The optical detector may include a focusing lens disposed between the dual LC wavelength-tunable filter and the optical detector and may be composed of a third photodiode for detecting an optical intensity from polarized light transmitted via the focusing lens.

The optical detector may have an active area of several millimeters to detect an optical intensity from polarized light transmitted via the dual LC wavelength-tunable filter.

The half-wavelength retarder may be composed of a first tunable retarder through which the polarized light of the TM mode of the beam displacer is transmitted and a second tunable retarder through which the polarized light of the TE mode of the beam displacer is transmitted.

The dual LC wavelength-tunable filter may be disposed at a rear end of the first tunable retarder or the second tunable retarder, the focusing lens may be disposed at a rear end of the dual LC wavelength-tunable filter, and an optical-power-attenuation-type linear-polarization narrow-band light output unit may be disposed at a rear end of the focusing lens.

According to another aspect of the present invention, there is provided a polarimetric-analysis-type dual LC wavelength filter module mounted on a TO-CAN-based package, the polarimetric-analysis-type dual LC wavelength filter module including a base structure protruding from a TO-STEM of the package, a sub-mount disposed over the base structure, a temperature control thermoelement mounted on the sub-mount, and a beam displacer, a half-wavelength retarder, a dual LC wavelength-tunable filter, and an optical detector that are bonded on a substrate over the thermoelement and sequentially arranged along a light propagation path.

The optical detector may be composed of a plurality of photodiodes disposed apart in a direction vertical to a protruding direction of the base structure protruding from the TO-STEM.

The half-wavelength retarder may be provided in singular or plural.

The optical detector may be composed of a single or a plurality of photodiodes.

The focusing lens may be disposed between the optical detector and the dual LC wavelength-tunable filter.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view of a Wollaston prism according to a conventional technology;

FIGS. 2A and 2B are views illustrating a change in birefringence by using a liquid crystal (LC) according to another conventional technology;

FIG. 3 is a perspective view of a Fabry-Perot LC filter according to still another conventional technology;

FIG. 4 is a graph showing a transmission spectrum according to voltage modulation in the Fabry-Perot LC filter shown in FIG. 3;

FIG. 5A is a block diagram of a polarimetric-analysis-type dual LC wavelength filter module according to an embodiment of the present invention, and

FIG. 5B is an operation diagram of the polarimetric-analysis-type dual LC wavelength filter module shown in FIG. 5A;

FIG. 6A is a block diagram of a polarimetric-analysis-type dual LC wavelength filter module according to an application example of the present invention, and FIG. 6B is an operation diagram of the polarimetric-analysis-type dual LC wavelength filter module shown in FIG. 6A;

FIG. 7A is a block diagram of a polarimetric-analysis-type dual LC wavelength filter module according to another application example of the present invention, and FIG. 7B is an operation diagram of the polarimetric-analysis-type dual LC wavelength filter module shown in FIG. 7A;

FIG. 8 is a perspective view of a package of the polarimetric-analysis-type dual LC wavelength filter module shown in FIG. 5A; and

FIG. 9 is a graph illustrating a principle in which the polarimetric-analysis-type dual LC wavelength filter module package shown in FIG. 8 may be used as a communication narrow-band wavelength filter.

### DETAILED DESCRIPTION OF EXEMPLARY EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terminology used herein is for the purpose of describing embodiments only and is not intended to be limiting of the present invention. As used herein, the singular forms “a,” “an” and “the” are intended to include the plural forms as well, unless the context clearly indicates otherwise. The terms “comprises” and/or “comprising,” when used in this specification, specify the presence of stated elements, steps, operations, and/or components, but do not preclude the presence or addition of one or more other elements, steps, operations, and/or components.

Hereinafter, example embodiments of the present invention will be described in detail with reference to the accompanying drawings.

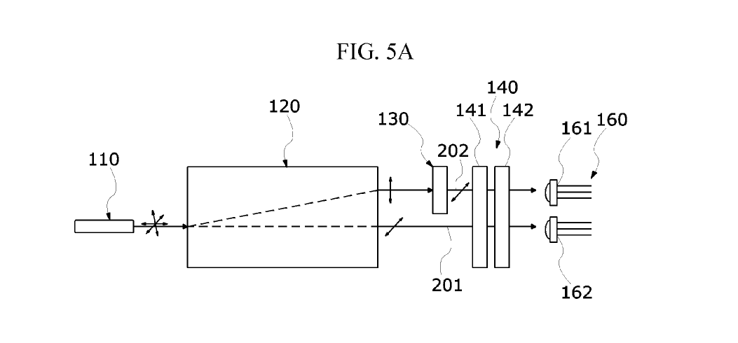

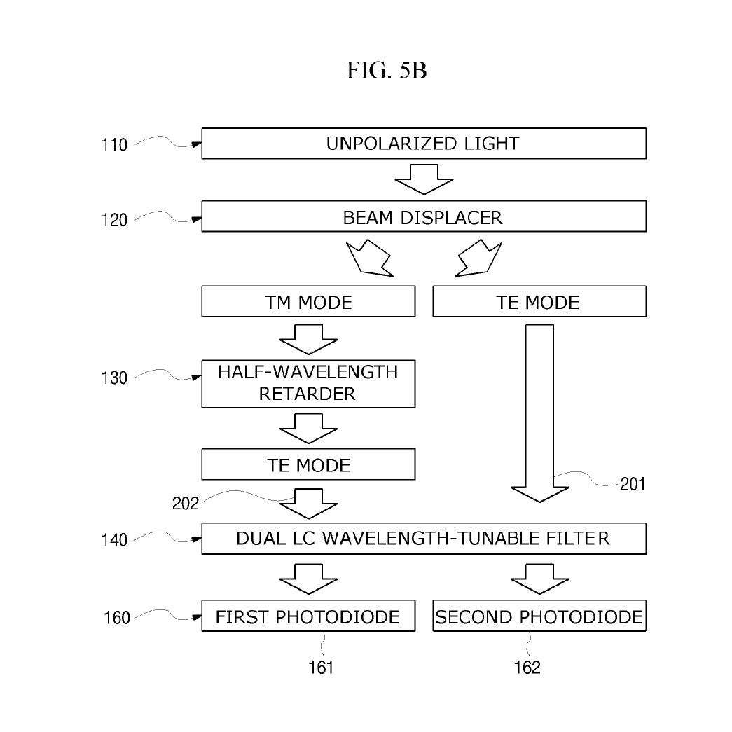

FIG. 5A is a block diagram of a polarimetric-analysis-type dual LC wavelength filter module according to an embodiment of the present invention, and FIG. 5B is an operation diagram of the polarimetric-analysis-type dual LC wavelength filter module shown in FIG. 5A.

Referring to FIGS. 5A and 5B, a polarimetric-analysis-type dual LC wavelength filter module according to this embodiment discloses an apparatus associated with an unpolarized light source 110 configured to emit unpolarized light. The polarimetric-analysis-type dual LC wavelength filter module according to this embodiment includes a beam displacer 120 disposed on a propagation path of light of the unpolarized light source 110 and configured to generate two orthogonal polarization components corresponding to two polarization axes from the light of the unpolarized light source 110 so that the orthogonal polarization components are separated at a predetermined angle.

Also, the polarimetric-analysis-type dual LC wavelength filter module according to this embodiment includes a half-wavelength retarder 130 disposed apart at a rear end of the beam displacer 120 along the light propagation path.

The half-wavelength retarder 130 is configured to modulate polarization components divergent from the beam displacer 120 and compensate for optical loss when a voltage is applied. That is, the half-wavelength retarder 130 is responsible for converting polarized light of a Transverse Magnetic (TM) mode, which is the orthogonal polarization components of the polarization axes, into polarized light of a Transverse Electric (TE) mode, which may be transmitted through LC wavelength-tunable filters 141 and 142.

Also, the polarimetric-analysis-type dual LC wavelength filter module according to this embodiment includes a dual LC wavelength-tunable filter 140 having the two LC wavelength-tunable filters 141 and 142 that overlap with a gap therebetween along the light propagation path to detect light intensities of first polarized light 201 of the TE mode that is directly delivered from the beam displacer 120 and second polarized light 202 of the TE mode that is transmitted through or via the half-wavelength retarder 130 and then converted.

The dual LC wavelength-tunable filter 140 is disposed at a rear end of the half-wavelength retarder 130 along the light propagation path.

Also, the polarimetric-analysis-type dual LC wavelength filter module according to this embodiment includes an optical detector 160 configured to detect the light intensities of the first polarized light 201 and the second polarized light 202 that are transmitted through the dual LC wavelength-tunable filter 140.

The optical detector 160 is disposed at a rear end of the dual LC wavelength-tunable filter 130.

The optical detector 160 may include a first photodiode 161 disposed on a light path of the second polarized light 202 and a second photodiode 162 disposed on a light path of the first polarized light 201 with respect to a position where light is emitted from the dual LC wavelength-tunable filter 140. That is, the light of the unpolarized light source 110 is divided into polarized light of the TE mode, which is a vertical component of a polarization axis, and polarized light of the TM mode, which is a horizontal component of the polarization axis, through the beam displacer 120.

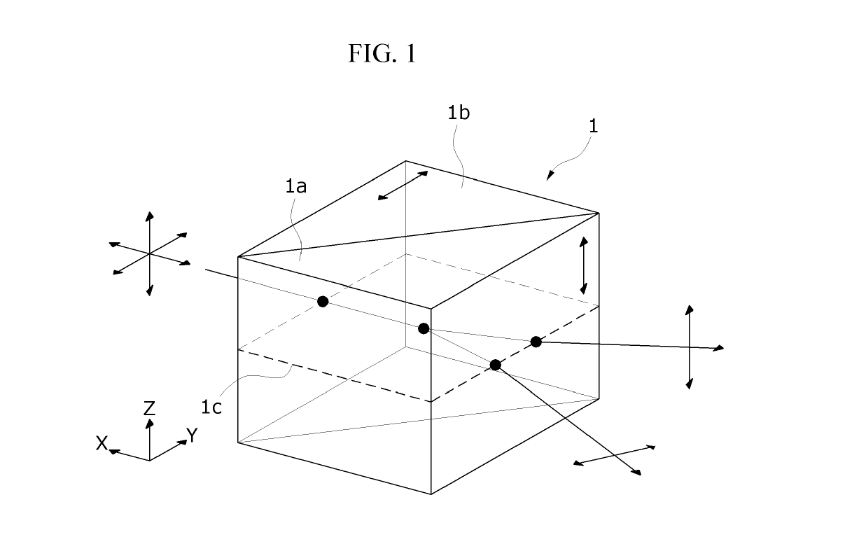

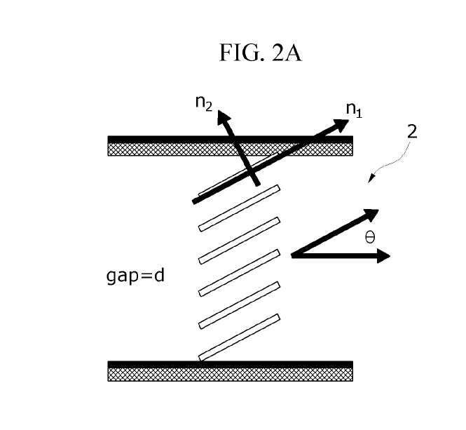

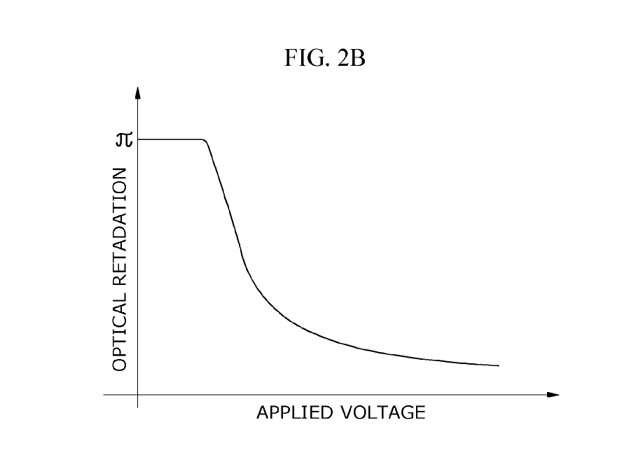

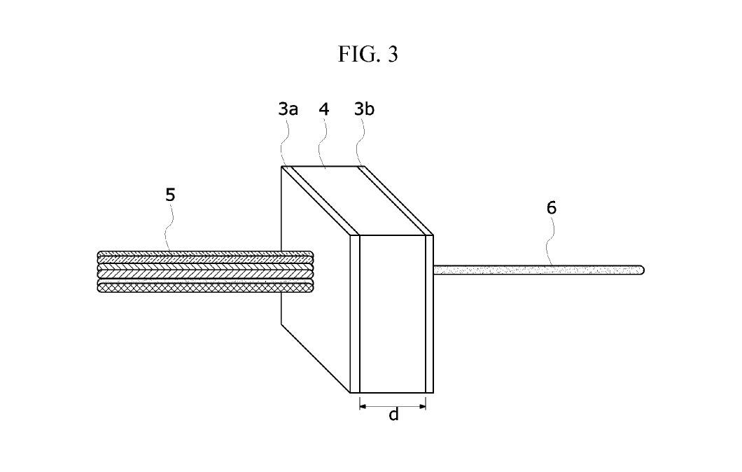

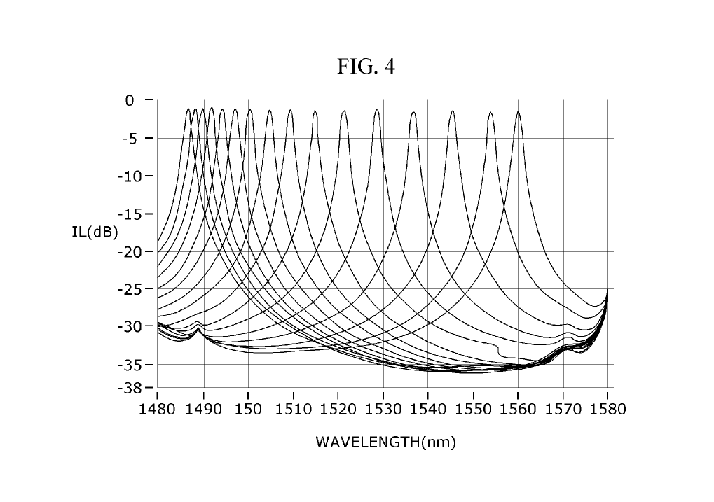

Here, the TM mode is a state in which an electric field direction (a polarization axis) is parallel to an incident surface (e.g., an X-Y plane 1c corresponding to the light propagation path in FIG. 1) (P-polarization), and the TE mode is a state in which vibration directions of the electric field traverse the incident surface, that is, are orthogonal to each other (S-polarization).

The beam displacer 120 with high birefringence properties may be implemented using an isotropic crystal device such as, for example, yttrium orthovanadate (YVO₄), calcite, rutile (TiO₂), and lithium niobate (NiNbO₃).

Each of the LC wavelength-tunable filters 141 and 142 transmits only one polarized wavelength according to its configuration position. In order to measure optical power without polarization loss of the incident light, polarized light having orthogonal polarization components among polarized light having two polarization components should be converted into polarized light that may be transmitted through the LC wavelength-tunable filters 141 and 142.

The half-wavelength retarder 130 is a half-wavelength retarder for compensating for optical loss caused by 90-degree polarization, which is installed at a front end of the dual LC wavelength-tunable filter 140.

For example, the half-wavelength retarder 130 may be a fixed half-wavelength retarder or a tunable retarder configured to use an LC.

The second polarized light 202 transmitted through or via the half-wavelength retarder 130 and the first polarized light 201 of the beam displacer 120 is transmitted through the dual LC wavelength-tunable filter 140 having the two LC wavelength-tunable filters 141 and 142 disposed to overlap each other. The first photodiode 161 and the second photodiode 162, which are included in the optical detector 160, detect light intensities from the second polarized light 202 and the first polarized light 201.

Subsequently, when two values of the optical power are combined, it is possible to check the polarization properties of the unpolarized light source 110, which is an incident light source. Accordingly, a module for measuring a wavelength change value and a polarization state of the unpolarized light source 110, which is the incident light source, at the same time may be implemented through the dual LC wavelength-tunable filter 140 and the optical detector 160 composed of the two photodiodes 161 and 162.

When such a module is utilized, it may be easy to implement an array system of a plurality of optical current transformers (CTs) because the module is capable of polarimetric analysis for each wavelength and miniaturized.

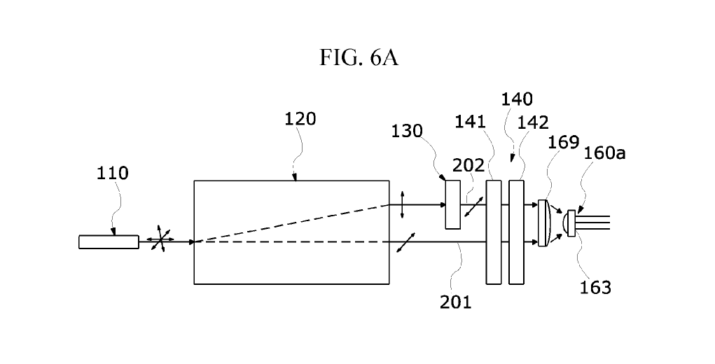

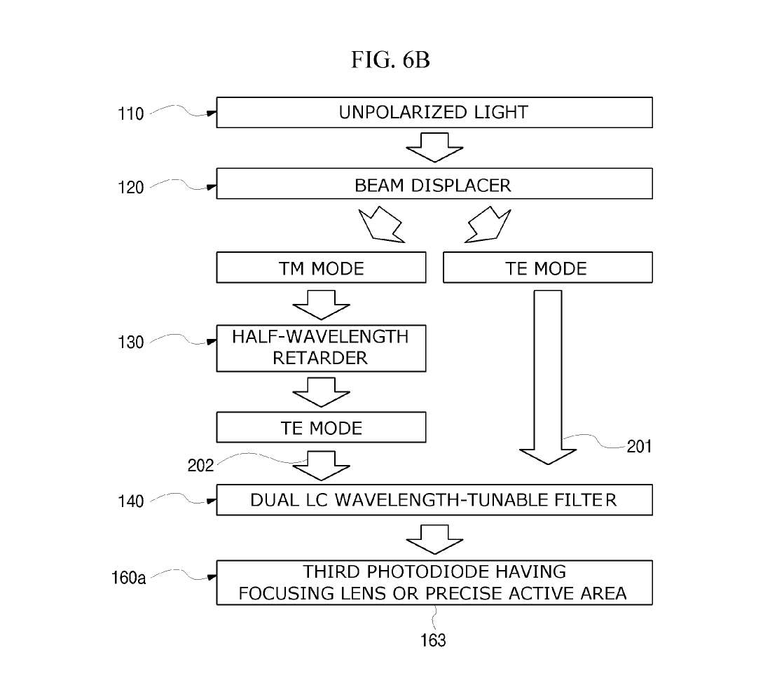

FIG. 6A is a block diagram of a polarimetric-analysis-type dual LC wavelength filter module according to an application example of the present invention, and FIG. 6B is an operation diagram of the polarimetric-analysis-type dual LC wavelength filter module shown in FIG. 6A.

Referring to FIGS. 6A and 6B, the polarimetric-analysis-type dual LC wavelength filter module includes the unpolarized light source 110, the beam displacer 120, the half-wavelength retarder 130, and the dual LC wavelength-tunable filter 140 that are the same as those described above.

Unlike the above-described embodiment, the polarimetric-analysis-type dual LC wavelength filter module further includes a focusing lens 169 disposed between the dual LC wavelength-tunable filter 140 and an optical detector 160a.

Also, the optical detector 160a may be composed of a third photodiode 163 configured to detect an optical intensity from polarized light transmitted via the focusing lens 169.

In this case, the third photodiode 163 may be an optical detector that is used together with the focusing lens 169. Also, according to the present invention, another optical detector with high precision (e.g., an active area of several millimeters) may be used such that it is not necessary to use the focusing lens 169.

The polarimetric-analysis-type dual LC wavelength filter module of FIG. 6A may be an optical power and wavelength measurement module that is easy to implement by modifying the proposed structure that has been described with reference to FIG. 5A.

As shown in FIGS. 6A and 6B, two light beams obtained by transmission through the dual LC wavelength-tunable filter 140 having the two LC wavelength-tunable filters 141 and 142 disposed to overlap each other, that is, the first polarized light 201 of the TE mode that is directly delivered from the beam displacer 120 and the second polarized light 202 of the TE mode that is transmitted through or via the half-wavelength retarder 130 and then converted are incident to the third photodiode 163, which is one optical detector 160a, through the focusing lens 169.

The light incident to the third photodiode 163 may be measured as an accurate power value and wavelength value, regardless of the polarization properties of the LC wavelength-tunable filters 141 and 142.

In this way, when the third photodiode 163 combined with the focusing lens 169 or a precise third photodiode 163 without the focusing lens 169 has a precise active area, the optical detector 160a may be produced in a small optical integrated module structure.

That is, when the third photodiode 163 is combined with the focusing lens 169 and used or when the third photodiode 163 itself is an optical detector having an active area of several millimeters without the focusing lens 169, the third photodiode 163 may detect two polarized light beams 201 and 202 obtained through division through the beam displacer 120 with respect to the polarization axes at the same time. Accordingly, it is possible to implement a mobile optical power and wavelength meter and a mobile spectrum analyzer.

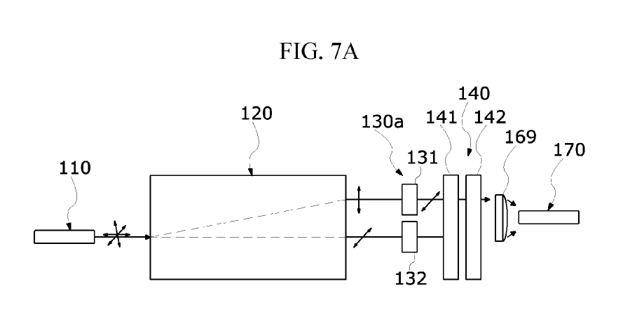

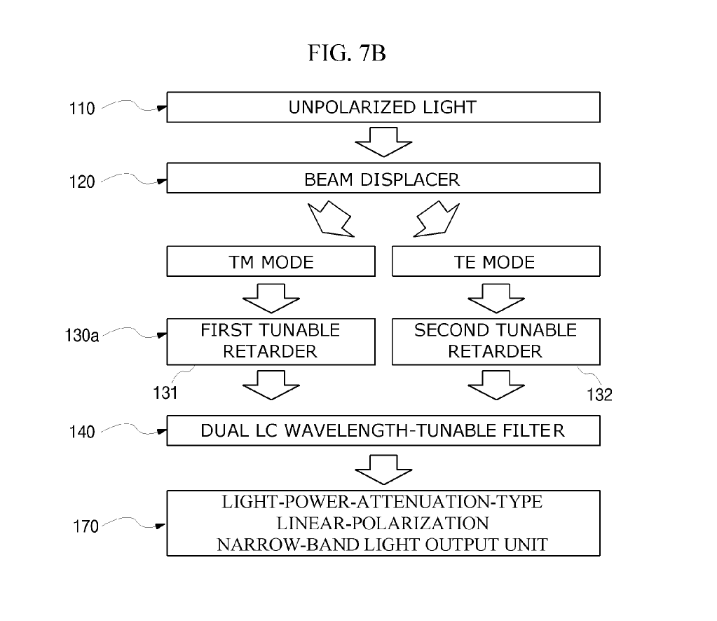

FIG. 7A is a block diagram of a polarimetric-analysis-type dual LC wavelength filter module according to another application example of the present invention, and FIG. 7B is an operation diagram of the polarimetric-analysis-type dual LC wavelength filter module shown in FIG. 7A.

Referring to FIGS. 7A and 7B, a polarimetric-analysis-type dual LC wavelength filter module 130a according to another application example of the present invention may include a first tunable retarder 131 through which the polarized light of the TM mode of the beam displacer 120 is transmitted and a second tunable retarder 132 through which the polarized light of the TE mode of the beam displacer 120 is transmitted.

Also, each of the first tunable retarder 131 and the second tunable retarder 132 may be a fixed half-wavelength retarder or a tunable retarder configured to use an LC that may adjust birefringence, as described above.

Also, in the polarimetric-analysis-type dual LC wavelength filter module 130a according to another application example of the present invention, the dual LC wavelength-tunable filter 140 may be disposed at a rear end of the first tunable retarder 131 or the second tunable retarder 132, the focusing lens 169 may be disposed at a rear end of the dual LC wavelength-tunable filter 140, and an optical-power-attenuation-type linear-polarization narrow-band light output unit 170 may be disposed at a rear end of the focusing lens 169.

That is, the polarimetric-analysis-type dual LC wavelength filter module 130a of FIG. 7A may be an optical filter module for optical-power-and-wavelength-tunable linear-polarization or a narrow-band-light-tunable power and wavelength filter, excluding the use of optical detection, by modifying the optical structure that has been described above with reference to FIG. 6A.

That is, orthogonal polarization components of light incident from the unpolarized light source 110 to the beam displacer 120 are separated at a certain angle through the beam displacer 120. Subsequently, polarization states of the divided light beams may be adjusted by transmitting the light beams through the first tunable retarder 131 or the second tunable retarder 132 capable of polarization state adjustment.

Subsequently, the adjusted light beams are transmitted through the dual LC wavelength-tunable filter 140.

A transmission polarization axis direction of the dual LC wavelength-tunable filter 140 is adjusted by controlling the first tunable retarder 131 or the second tunable retarder 132 in this way.

Then, a tunable attenuation function for adjusting a power value of incident light may be implemented, and a linear polarizer module for varying the wavelength value and the power value at the same time may be implemented.

Also, as described in FIG. 7A, the light transmitted through the dual LC wavelength-tunable filter 140 may be focused on an optical fiber through the focusing lens. Thus, it is possible to utilize as a polarization switch depending on a polarization axis direction as well as a polarization filter of incident light.

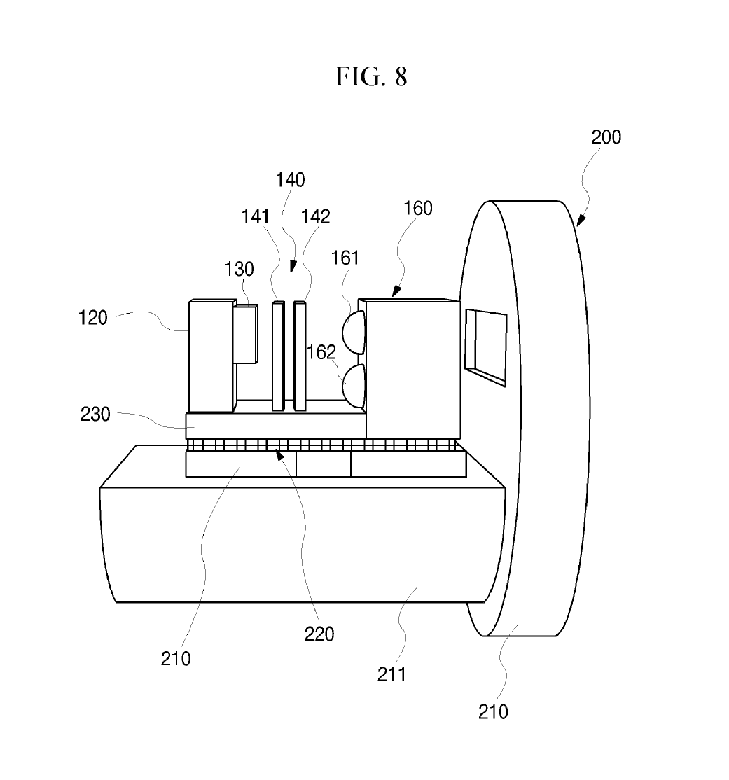

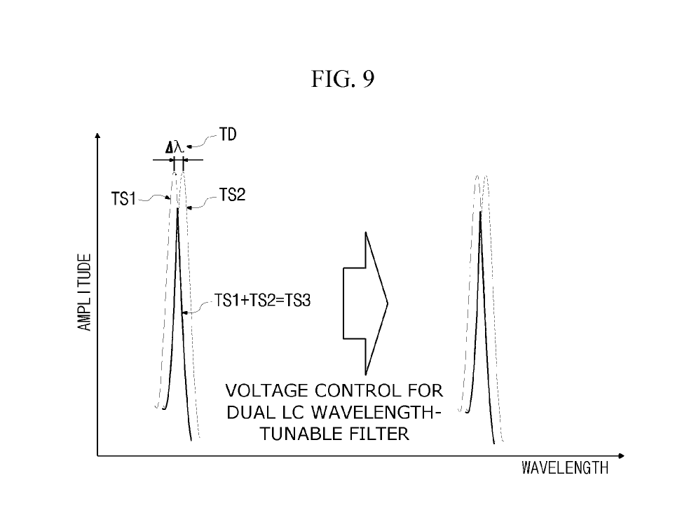

FIG. 8 is a perspective view of a package of the polarimetric-analysis-type dual LC wavelength filter module shown in FIG. 5A, and FIG. 9 is a graph illustrating a principle in which the polarimetric-analysis-type dual LC wavelength filter module package shown in FIG. 8 may be used as a communication narrow-band wavelength filter.

FIG. 8 may show an optical integrated apparatus of an optical module having the configuration that has been described with reference to FIGS. 5A and 5B.

In order to mount a polarimetric-analysis-type dual LC wavelength filter module of FIG. 8 on a TO-CAN-based package 200, the polarimetric-analysis-type dual LC wavelength filter module includes a base structure 211 protruding from a TO-STEM 201 of the package 200, a sub-mount 210 disposed over the base structure 211, a temperature control thermoelement 220 (thermo-electric cooling (TEC)) mounted on the sub-mount 210, and the beam displacer 120, the half-wavelength retarder 130, the dual LC wavelength-tunable filter 140, and the optical detector 160 that are bonded on a substrate 230 over the thermoelectric element 220 and sequentially arranged along a light propagation path.

The optical detector 160 may include a plurality of photodiodes 161 and 162 disposed apart from each other in a direction orthogonal to a protruding direction of the base structure 211 protruding from the TO-STEM 201.

The thermoelectric element 220 is responsible for temperature compensation due to a thermal change inside the package 200 and may be an element for radiating heat of the package 200.

Elements of the polarimetric-analysis-type dual LC wavelength filter module of the present invention may be integrated into one sub-mount 210 inside a small package 200 and manually aligned. Accordingly, it is possible to achieve cost reduction through mass production.

Referring to FIG. 9, in the polarimetric-analysis-type dual LC wavelength filter module of the present invention, a dual LC wavelength-tunable filter is formed of two LC wavelength-tunable filters overlapping with a gap therebetween. Accordingly, it is possible to increase its dynamic range.

Also, an overlapping wavelength and a wavelength passband of the two LC wavelength-tunable filters may be adjusted by adjusting a voltage difference for driving the dual LC wavelength-tunable filter.

The adjustment of a voltage difference for driving the dual LC wavelength-tunable filter may refer to a voltage control for the dual LC wavelength-tunable filter shown in FIG. 9.

As shown in FIG. 9, TS1 may denote a transmission spectrum of a first LC wavelength-tunable filter, TS2 may denote a transmission spectrum of a second LC wavelength-tunable filter, and TS1+ST2=TS3 may denote a transmission spectrum of the dual LC wavelength-tunable filter.

In the related art, it is difficult to implement a transmission wavelength in a narrow band because of physical properties of one LC wavelength-tunable filter. However, when a dual LC wavelength-tunable filter having two LC wavelength-tunable filters disposed to overlap each other is applied according to the present invention, a continuous LC-based narrow-band wavelength-tunable filter for adjusting a passband width caused by a time difference may be implemented by using a control (e.g., a time difference control) of a operating time difference Δλ between the LC wavelength-tunable filters.

Also, when productization is performed on the package 200 of FIG. 8 by applying FIGS. 5A to 7B that have been described above, the optical detector 160 may include a single or a plurality of photodiodes.

Also, the half-wavelength retarder 130 may be provided in singular or plural, or the focusing lens that has been described above may be disposed between the optical detector 160 and the dual LC wavelength-tunable filter 140.

According to the present invention, it is possible to perform mass production of a miniaturized product in which a beam displacer, a half-wavelength retarder, and a dual LC wavelength-tunable filter are organically combined.

According to the present invention, it is also possible to detect a narrow-band wavelength without polarization-dependent loss by using two LC wavelength filters in a time delay technique and easily perform modularization by stacking an optical device on one package without a focusing lens.

According to the present invention, it is also possible to enable mass production and low pricing and facilitate development of an additional application product (e.g., a spectrum analyzer, a gas sensor, a wavelength sensor, etc.) built in a mobile device because a small product is modularized compared to the conventional bulky optical component.

The above-described subject matter of the present invention is to be considered illustrative and not restrictive, and it should be understood that numerous other modifications and embodiments can be devised by those skilled in the art without departing from the spirit and scope of the present invention. Accordingly, the embodiments of the present invention are to be considered descriptive and not restrictive of the present invention, and do not limit the scope of the present invention. The scope of the invention should be to be construed by the appended claims, and all technical ideas within the scope of their equivalents should be construed as being included in the scope of the invention.

What is claimed is:

1. A polarimetric-analysis-type dual liquid crystal (LC) wavelength filter module comprising:
a beam displacer disposed on a propagation path of light of an unpolarized light source that emits unpolarized light and configured to generate two orthogonal polarization components corresponding to two polarization axes from the light of the unpolarized light source such that the polarization components are separated at a predetermined angle;
a half-wavelength retarder disposed apart at a rear end of the beam displacer along the light propagation path; and
a dual LC wavelength-tunable filter having two LC wavelength-tunable filters that overlap with a gap therebetween to detect light intensities of first polarized light of a Transverse Electric (TE) mode that is directly delivered from the beam displacer and second polarized light of the TE mode that is transmitted through or via the half-wavelength retarder and then converted.

2. The polarimetric-analysis-type dual LC wavelength filter module of claim 1, wherein the half-wavelength retarder is a fixed half-wavelength retarder or a tunable retarder that uses a LC, and is composed of a device for converting polarized light of a Transverse Magnetic (TM) mode, which is the orthogonal polarization components of the polarization axes, into polarized light of the TE mode, which is capable of being transmitted through the LC wavelength-tunable filters.

3. The polarimetric-analysis-type dual LC wavelength filter module of claim 1, further comprising an optical detector disposed at a rear end of the dual LC wavelength-tunable filter and configured to detect optical intensities of the first polarized light and the second polarized light that are transmitted through the dual LC wavelength-tunable filter.

4. The polarimetric-analysis-type dual LC wavelength filter module of claim 3, wherein the optical detector is composed of a first photodiode disposed on a light path of the second polarized light and a second photodiode disposed on a light path of the first polarized light with respect to a position where light is emitted from the dual LC wavelength-tunable filter.

5. The polarimetric-analysis-type dual LC wavelength filter module of claim 3, wherein the optical detector includes a focusing lens disposed between the dual LC wavelength-tunable filter and the optical detector and is composed of a third photodiode for detecting an optical intensity from polarized light transmitted via the focusing lens.

6. The polarimetric-analysis-type dual LC wavelength filter module of claim 3, wherein the optical detector has an active area of several millimeters to detect an optical intensity from polarized light transmitted via the dual LC wavelength-tunable filter.

7. The polarimetric-analysis-type dual LC wavelength filter module of claim 1, wherein the half-wavelength retarder is composed of a first tunable retarder through which the polarized light of the TM mode of the beam displacer is transmitted and a second tunable retarder through which the polarized light of the TE mode of the beam displacer is transmitted.

8. The polarimetric-analysis-type dual LC wavelength filter module of claim 7, wherein the dual LC wavelength-tunable filter is disposed at a rear end of the first tunable retarder or the second tunable retarder, the focusing lens is disposed at a rear end of the dual LC wavelength-tunable filter, and an optical-power-attenuation-type linear-polarization narrow-band light output unit is disposed at a rear end of the focusing lens.

9. A polarimetric-analysis-type dual LC wavelength filter module mounted on a TO-CAN-based package, the polarimetric-analysis-type dual LC wavelength filter module comprising:
a base structure protruding from a TO-STEM of the package;
a sub-mount disposed over the base structure;
a temperature control thermoelement mounted on the sub-mount; and
a beam displacer, a half-wavelength retarder, a dual LC wavelength-tunable filter, and an optical detector that are bonded on a substrate over the thermoelement and sequentially arranged along a light propagation path.

10. The polarimetric-analysis-type dual LC wavelength filter module of claim 9, wherein the optical detector is composed of a plurality of photodiodes disposed apart in a direction vertical to a protruding direction of the base structure protruding from the TO-STEM.

11. The polarimetric-analysis-type dual LC wavelength filter module of claim 9, wherein the half-wavelength retarder is provided in singular or plural.

12. The polarimetric-analysis-type dual LC wavelength filter module of claim 9, wherein the optical detector is composed of a single or a plurality of photodiodes.

13. The polarimetric-analysis-type dual LC wavelength filter module of claim 12, wherein the focusing lens is disposed between the optical detector and the dual LC wavelength-tunable filter.
